(19) United States
(12) Patent Application Publication
(10) Pub. No.: US 2016/0344729 A1
(43) Pub. Date: Nov. 24, 2016

(54) TECHNOLOGIES FOR GEOLOCATION ATTESTATION OF COMPUTING DEVICES IN A NETWORK PATH

(71) Applicants: Thomas M. Slaight, Beaverton, OR (US); Brian J. Skerry, Gilbert, AZ (US); Kapil Sood, Beaverton, OR (US); Ren Wang, Portland, OR (US)

(72) Inventors: Thomas M. Slaight, Beaverton, OR (US); Brian J. Skerry, Gilbert, AZ (US); Kapil Sood, Beaverton, OR (US); Ren Wang, Portland, OR (US)

(21) Appl. No.: 14/670,856

(22) Filed: Mar. 27, 2015

(51) Int. Cl. H04L 29/06; H04L 12/26; H04L 9/32; H04L 12/721

(52) U.S. Cl. CPC H04L 63/0876; H04L 45/123; H04L 43/106; H04L 63/061; H04L 63/0435; H04L 9/3247; H04L 9/3297; H04L 63/0442

(57) ABSTRACT

Technologies for geolocation attestation of computing devices in a network path include a verification device to generate a secure trace packet such that the secure trace packet includes a timestamp that corresponds with a departure time of the secure trace packet from the verification device. The computing device transmits the secure trace packet to a computing device in the network path. The network path identifies one or more intermediate devices through which to communicate the secure trace packet from the verification device to a target computing device. The computing device verifies a signature of a cryptographically-signed secure trace packet received by the verification computing device from the computing device and determines whether a sub-path of the network path is authorized based on the cryptographically-signed secure trace packet and reference network path data, which indicates a maximum allowed geographical distance between two computing devices in the network path.

### BACKGROUND

In various circumstances, it may be important to a particular data center customer that the data center and/or any communication transmissions be maintained within a particular geolocation such as a particular country or region. For example, the United States government may desire that all operations and communications related to a certain project be done with computing devices within the geographical boundaries of the United States. Further, in some cases, an attacker may even attempt to maliciously and covertly remove a system and relocate it outside the data center in order to analyze the system and its traffic under operation. However, it is often difficult to determine the geolocation of a target computing system and/or the geolocations of the particular intermediary computing systems in the network path between a data center and the target computing system. As such, a data center may struggle to provide such assurances to those customers. In an effort to provide some geolocation information, some data centers utilize hardware-based solutions that attempt to physically associate a computing system with a component that already has a known location (e.g., a computer rack that holds the computing system). However, such solutions often require specialized hardware and/or other mechanisms to detect the connection between the hardware components themselves.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for attesting the geolocation of computing devices in a network path;

FIG. 2 is a simplified block diagram of at least one embodiment of a computing device of the system of FIG. 1;

FIG. 3 is a simplified block diagram of at least one embodiment of an environment of a verification computing device of the system of FIG. 1;

FIG. 4 is a simplified block diagram of at least one embodiment of an environment of the computing device of FIG. 2;

FIG. 5 is a simplified flow diagram of at least one embodiment of a method for attesting the geolocation of computing devices in a network path that may be executed by the verification computing device of the system of FIG. 1;

FIGS. 6-7 is a simplified flow diagram of at least one embodiment of a method for facilitating attestation of the geolocation of computing devices in a network path that may be executed by a computing device of the system of FIG. 1; and

FIG. 8 is a simplified data flow diagram of at least one embodiment of the methods of FIGS. 5-7.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

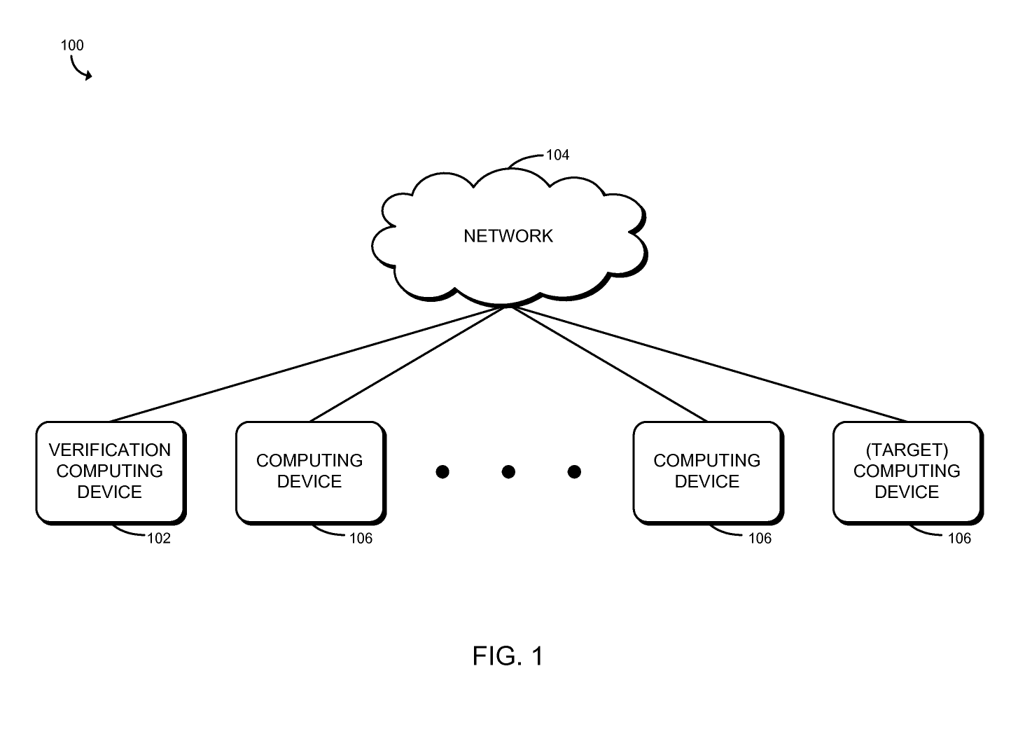

Referring now to FIG. 1, a system 100 for attesting the geolocation of computing devices in a network path includes a verification computing device 102, a network 104, and one or more computing devices 106. Although only one verification computing device 102 and one network 104 are illustratively shown in FIG. 1, the system 100 may include any number of verification computing devices 102 and/or networks 104 in other embodiments. For example, the verification computing device 102 may transmit a network packet to a target computing device 106 through several other computing devices 106 (i.e., intermediate computing devices) depending on the particular network flow. In particular, in the illustrative embodiment, the computing devices 102, 106 of the system 100 may be established in a serial relationship such that the verification computing device 102 communicates with a first computing device 106 over a first network 104, the first computing device 106 communicates with a second computing device 106 over a second network 104, and so on, until the transmission from the verification computing device 102 reaches the target computing device 106. Accordingly, in some embodiments, the verification computing device 102 does not have direct communication connections to each of the computing devices 106.

As described in detail below, the verification computing device 102 confirms that each hop (i.e., each computing device 106) in a network path between the verification computing device 102 and the target computing device 106 (i.e., the computing device to which a particular network packet is directed) is within an authorized geolocation. In particular, each of the computing devices 106 in the network path may “incrementally” sign secure trace packets (e.g., network packets including entry and/or departure timestamps) that are returned to the verification computing device 102 for analysis as described below. It should be appreciated that the verification computing device 102 may confirm one or more sub-paths in the network path (e.g., a network connection between two computing devices 106) and/or the overall network path in order to infer the geolocation of the computing devices 106 depending on the particular embodiment. Further, in some embodiments, by measuring the time elapsed between hops (e.g., the duration of a particular sub-path), the verification computing device 102 may mitigate the possibility of man-in-the-middle and insertion attacks on the system 100.

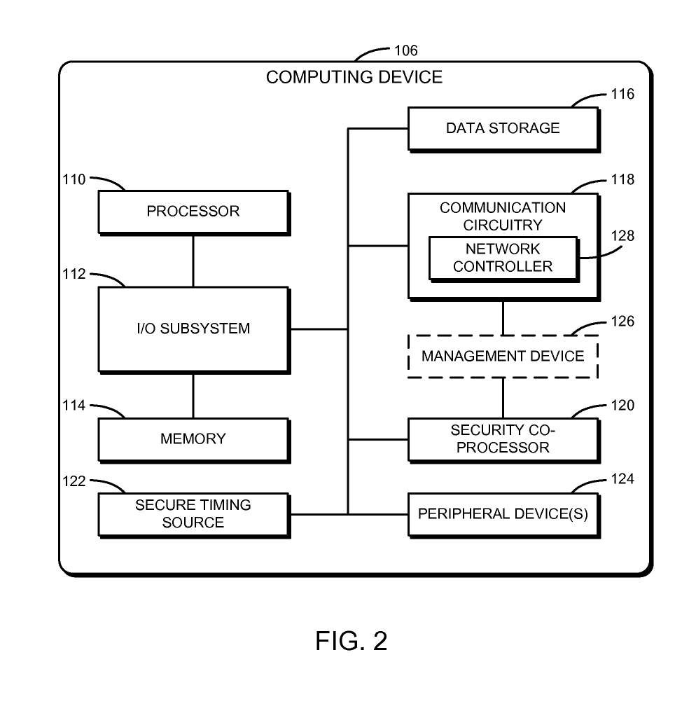

Referring now to FIG. 2, an illustrative embodiment of one of the computing devices 106 is shown. Each of the computing devices 106 may be embodied as any type of computing device capable of performing the functions described herein. For example, each of the computing devices 106 may be embodied as a desktop computer, server, router, switch, laptop computer, tablet computer, notebook, netbook, Ultrabook™, cellular phone, smartphone, wearable computing device, personal digital assistant, mobile Internet device, Hybrid device, and/or any other computing/communication device. As shown in FIG. 2, the illustrative computing device 106 includes a processor 110, an input/output (“I/O”) subsystem 112, a memory 114, a data storage 116, a communication circuitry 118, a security co-processor 120, a secure timing source 122, and one or more peripheral devices 124. Additionally, in some embodiments, the computing device 106 may include a management device 126. Of course, the computing device 106 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 114, or portions thereof, may be incorporated in the processor 110 in some embodiments.

The processor 110 may be embodied as any type of processor capable of performing the functions described herein. For example, the processor 110 may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the computing device 106 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the computing device 106. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the computing device 106, on a single integrated circuit chip.

The data storage 116 may be embodied as any type of device or devices configured for short-term or long-term storage of data such as, for example, memory devices and circuits, memory cards, hard disk drives, solid-state drives, or other data storage devices. The data storage 116 and/or the memory 114 may store various data during operation of the computing device 106 useful for performing the functions described herein. For example, the computing device 106 may include a table identifying the various computing devices 102, 106 in a particular network path/flow.

The communication circuitry 118 may be embodied as any communication circuit, device, or collection thereof, capable of enabling communications between the computing device 106 and other remote devices over the network 104 (e.g., the verification computing device 102 and other computing devices 106). The communication circuitry 118 may be configured to use any one or more communication technologies (e.g., wireless or wired communications) and associated protocols (e.g., Ethernet, Bluetooth®, Wi-Fi®, WiMAX, etc.) to effect such communication. As shown, in the illustrative embodiments, the communication circuitry 118 includes a network controller 128 (e.g., a network interface card). It should be appreciated that the network controller 128 may be embodied as any component(s) or circuitry capable of performing the functions described herein. In some embodiments, the network controller 128 includes a sideband filtering component or capability that routes packets to the management device 124 (e.g., a manageability controller) or directly to the security co-processor 120. That is, the network controller 128 may communicate with the security co-processor 120 by virtue of an out-of-band communication channel between those components and/or the management device 126. Further, in some embodiments, the network controller 128 recognizes and routes the relevant packets to the management device 126 or the security co-processor 120 and interleaves that traffic with the in-band traffic to and from the host operating system.

The security co-processor 120 may be embodied as any hardware component(s) or circuitry capable of performing the cryptographic, attestation, and other functions described herein. For example, the security co-processor 120 may be embodied as a Trusted Platform Module (TPM), a Converged Security and Manageability Engine (CSME), a security engine, or an out-of-band processor. As described herein, in some embodiments, the security co-processor 120 may establish an out-of-band communication link with the network controller 128 (e.g., by virtue of the management device 126). Depending on the particular embodiment, the security co-processor 120 may perform various security-related functions (e.g., attestation, encryption/decryption, cryptographic signature generation/verification, certificate generation/verification, and/or other security functions). For example, in some embodiments, the security co-processor 120 (e.g., a TPM) may be preconfigured/provisioned with a private cryptographic key (e.g., a private TPM key) that may be used to cryptographically sign network packets received from other computing devices 102, 106 (e.g., by signing a hash of timestamp values and/or other portions of secure trace packets).

The secure timing source 122 may be embodied as any hardware component(s) or circuitry capable of providing a secure timing signal and otherwise performing the functions described herein. For example, in the illustrative embodiment, the secure timing source 122 may generate a timing signal that is separate and functionally independent from other clock sources of the computing device 106. Accordingly, in such embodiments, the secure timing source 122 may be immune or resistant to alteration by other entities such as, for example, software executing on the computing device 106. It should be appreciated that, in some embodiments, the secure timing source 122 may be embodied as standalone component(s) or circuitry, whereas in other embodiments the secure timing source 122 may be integrated with or form a secure portion of another component (e.g., the processor 110, security co-processor 120, management device 126, or network controller 128, and/or another component). For example, in some embodiments, the secure timing source 122 may be implemented via an on-chip oscillator and/or embodied as a secure clock of a CSME or manageability engine (ME). It should further be appreciated that, depending on the particular embodiment, the secure timing source 122 of the computing devices 106 may or may not be synchronized to a secure clock of the verification computing device 102.

The peripheral devices 124 may include any number of additional peripheral or interface devices, such as speakers, microphones, additional storage devices, and so forth. The particular devices included in the peripheral devices 124 may depend on, for example, the type and/or intended use of the computing device 106.

The management device 126 may be embodied as any hardware component(s) or circuitry capable of performing management functions and otherwise performing the functions described herein. For example, in some embodiments, the management device 126 may be embodied as a management controller or manageability engine. Further, in some embodiments, the management device 126 may act as a liaison between the network controller 128 and the security co-processor 120 (e.g., to establish an out-of-band communication link between those components). In other embodiments, the management device 126 and the security co-processor 120 may be embodied as the same device.

Referring back to FIG. 1, the network 104 may be embodied as any type of communication network capable of facilitating communication between the verification computing device 102 and a computing device 106 and/or communication among the computing devices 106. As such, the network 104 may include one or more networks, routers, switches, computers, and/or other intervening devices. For example, the network 104 may be embodied as or otherwise include one or more cellular networks, telephone networks, local or wide area networks, publicly available global networks (e.g., the Internet), an ad hoc network, or any combination thereof.

The verification computing device 102 may be embodied as any computing device capable of performing the functions described herein. For example, the verification computing device 102 may be embodied as a desktop computer, server, router, switch, laptop computer, tablet computer, notebook, netbook, Ultrabook™, cellular phone, smartphone, wearable computing device, personal digital assistant, mobile Internet device, Hybrid device, and/or any other computing/communication device. Further, the verification computing device 102 may include components similar to the components of the computing device 106 described above and/or components commonly found in a computing device such as a processor, memory, I/O subsystem, data storage, peripheral devices, and so forth, which are not illustrated in FIG. 1 for clarity of the description.

Of course, the verification computing device 102 may include other or additional components, such as those commonly found in a typical computing device (e.g., various input/output devices and/or other components), in other embodiments. Further, in some embodiments, one or more of the components of the computing devices 106 may be omitted from the verification computing device 102. For example, in some embodiments, the security co-processor 120 and/or the management device 124 may be omitted from the verification computing device 102. Additionally, in some embodiments, one or more of the illustrative components may be incorporated in, or otherwise form a portion of, another component. Although the verification computing device 102 is described herein as the source of the data packet transmission to the target computing device 106 for clarity of the description, in other embodiments, the verification computing device 102 is not within the network path between the source and target computing devices 106. In such embodiments, the verification computing device 102 may nonetheless perform functions similar to those described herein based on the communication of secure trace packets and signatures between the verification computing device 102 and those computing devices 106 included in the network path.

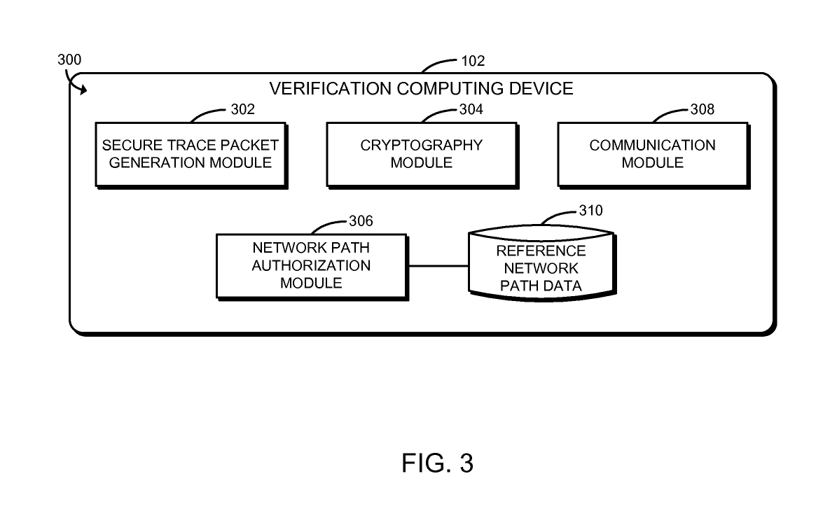

Referring now to FIG. 3, in use, the verification computing device 102 establishes an environment 300 for attesting the geolocation of computing devices 106 in a network path. The illustrative environment 300 of the verification computing device 102 includes a secure trace packet generation module 302, a cryptography module 304, a network path authorization module 306, and a communication module 308. The various modules of the environment 300 may be embodied as hardware, software, firmware, or a combination thereof. For example, the various modules, logic, and other components of the environment 300 may form a portion of, or otherwise be established by, the processor or other hardware components of the verification computing device 102. As such, in some embodiments, one or more of the modules of the environment 300 may be embodied as a circuit or collection of electrical devices (e.g., a secure trace packet generation circuit, a cryptography circuit, a network path authorization circuit, and/or a communication circuit). Additionally, in some embodiments, one or more of the illustrative modules may form a portion of another module and/or one or more of the illustrative modules may be embodied as a standalone or independent module.

The secure trace packet generation module 302 is configured to generate secure trace packets on behalf of the computing device 102. In the illustrative embodiment, secure trace packets generated by the computing device 102 are embodied as data packets (e.g., network packets) that include a departure timestamp corresponding with a departure time of the particular data packet from the computing device 102. It should be appreciated that the secure trace packets may be embodied as any suitable data (e.g., a data block) for securely conveying a timestamp and otherwise suitable for the performance of the functions described herein. Additionally, the secure trace packet generation module 302 may utilize any suitable technique and/or algorithm to generate timestamps.

The cryptography module 304 performs various cryptographic functions for the verification computing device 102. Depending on the particular embodiment, the cryptography module 304 may be embodied as a cryptographic engine, an independent security co-processor of the verification computing device 102 (e.g., a security co-processor), a cryptographic accelerator incorporated into a main processor of the verification computing device 102, or a stand-alone cryptographic software/firmware. In some embodiments, the cryptography module 304 may generate and/or utilize various cryptographic keys (e.g., symmetric/asymmetric cryptographic keys) for encryption, decryption, signing, and/or signature verification. Similarly, the cryptography module 304 may receive cryptographic keys from remote computing devices for various cryptographic purposes. Additionally, in some embodiments, the cryptography module 304 may establish a secure connection with remote devices (e.g., the computing devices 106) over the network 104 (e.g., by virtue of the network controller 126). As described below, in the illustrative embodiment, the verification computing device 102 verifies signatures of cryptographically-signed secure trace packets received from other computing devices 106. Further, in some embodiments, the verification computing device 102 may receive secure trace packets that have been “wrapped” (e.g., iteratively signed) with several private cryptographic keys (e.g., private TPM keys) of different computing devices 106 in a particular network path in which case, the cryptography module 304 may verify each of those signatures (e.g., iteratively).

The network path authorization module 306 confirms or infers that a transmitted network packet has not left some authorized geolocation or geographical boundary within which the network packet is authorized to exist and the corresponding functions to operate based on reference network path data 310. In some embodiments, the reference network path data 310 is indicative of a maximum allowed geographical distance between two computing devices 102, 106 in the network path. In other embodiments, the reference network path data 310 may be embodied as any data associated with or capable of conveying a geographical location, geographical boundary, physical path, and/or other expected characteristics of a network path through which a data packet is to be transmitted. For example, in some embodiments, the reference network path data 310 may include a threshold time interval indicative of a duration of travel of a data packet such that the threshold time interval is associated with a maximum allowed geographical distance between two computing devices 102, 106 (e.g., based on time-of-flight, the speed of light, signal propagation characteristics, and/or other measureable characteristics relating time to distance). More specifically, in the illustrative embodiment, the network path authorization module 306 may compare the timestamp(s) received with the secure trace packet(s) to the corresponding reference network path data 310 to determine whether one or more sub-paths/connections between computing devices 102, 106 are authorized. Further, depending on the particular embodiment, the network path authorization module 306 may confirm the network paths (i.e., the sub-paths) between each of the computing devices 102, 106 in the overall network path from the verification computing device 102 to the target computing device 106 and/or the network path authorization module 306 may confirm the overall network path. It should be appreciated that if a network packet took a path outside of that expected (e.g., outside a particular data center of the verification computing device 102 or outside of the country), the techniques described herein help to detect the rogue network packet. For example, attacks by which an adversary hijacks a host operating system of one of the computing devices 106 in the network path and attempts to redirect network packets are often readily identifiable by the system 100.

The communication module 308 handles the communication between the verification computing device 102 and remote devices (e.g., the computing devices 106) through the network 104. For example, as described herein, the communication module 308 transmits the secure trace packet generated by the secure trace packet generation module 302 to the next computing device 106 in the network path (e.g., based on a network path table identifying the particular network hops). Additionally, the communication module 308 receives the cryptographically-signed secure trace packets from that computing device 106 in order to confirm that the network packet actually took a path within an authorized geolocation.

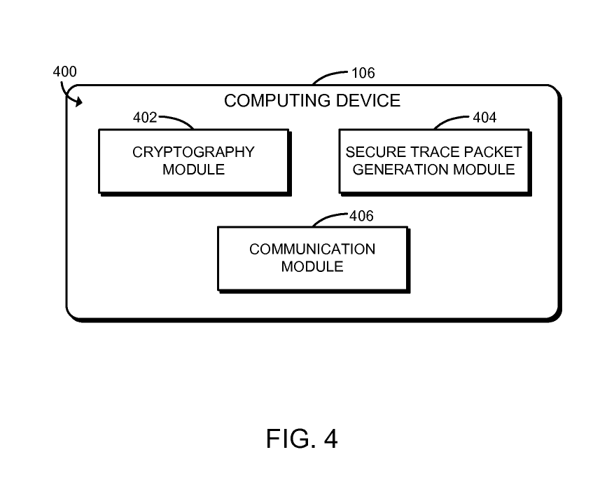

Referring now to FIG. 4, in use, each of the computing devices 106 establishes an environment 400 for facilitating attestation of the geolocation of computing devices 106 in a network path between a source and target computing device 102, 106. The illustrative environment 400 of the computing device 106 includes a cryptography module 402, a secure trace packet generation module 404, and a communication module 406. The various modules of the environment 400 may be embodied as hardware, software, firmware, or a combination thereof. For example, the various modules, logic, and other components of the environment 400 may form a portion of, or otherwise be established by, the processor 110 or other hardware components of the computing device 106. As such, in some embodiments, one or more of the modules of the environment 400 may be embodied as a circuit or collection of electrical devices (e.g., a cryptography circuit, a secure trace packet generation circuit, and/or a communication circuit). Additionally, in some embodiments, one or more of the illustrative modules may form a portion of another module and/or one or more of the illustrative modules may be embodied as a standalone or independent module.

The cryptography module 402 may be similar to the cryptography module 304 of the verification computing device 102. As such, depending on the particular embodiment, the cryptography module 402 may be configured to perform various cryptography functions for the computing device 106 including, for example, generating and/or utilizing various cryptographic keys (e.g., symmetric/asymmetric cryptographic keys) for encryption, decryption, signing, and/or signature verification. In particular, in some embodiments, the cryptography module 402 may cryptographically sign secure trace packets received from previous computing devices 102, 106 in the network path (e.g., with a private TPM key of the computing device 106) and return those signed packets to the corresponding previous computing device 102, 106. Further, in some embodiments, the cryptography module 402 may generate a hash of the timestamp(s) included in the secure trace packet (e.g., a keyed hash) and include the hash with the signed secure trace packet. For clarity of the description, the cryptography module 402 is described herein as signing the secure trace packet; however, in other embodiments, the cryptography module 402 may sign the timestamp(s) themselves.

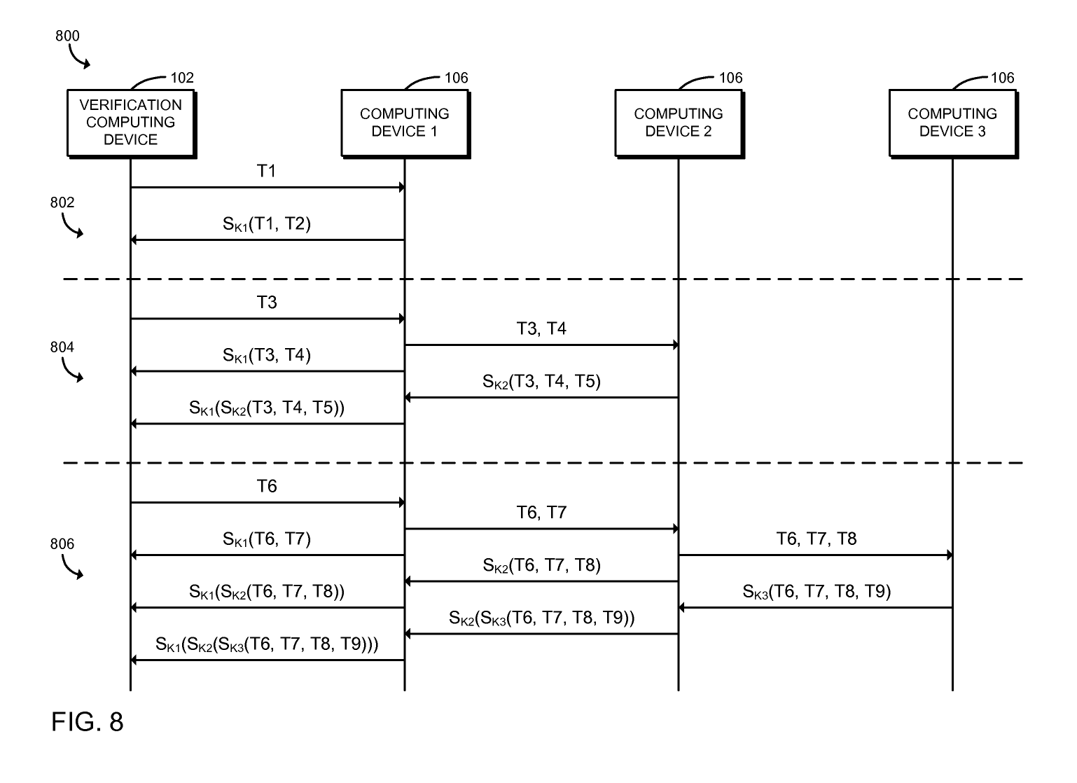

The secure trace packet generation module 404 may be similar to the secure trace packet generation module 302 of the verification computing device 102. Accordingly, in the illustrative embodiment, the secure trace packet generation module 404 is configured to generate secure trace packet on behalf of the computing device 106. In the illustrative embodiment, secure trace packets generated by the computing device 106 are embodied as data packets (e.g., network packets) that include an entry timestamp corresponding with an entry time of the particular data packet to the computing device 106 and/or a departure timestamp corresponding with a departure time of the particular data packet from the computing device 106 (e.g., to the next computing device in the network path). It should be appreciated that multiple timestamps included in a secure trace packet may be referred to herein as a single timestamp or as a timestamp interval for clarity of the description (see, for example, the discussion of FIG. 8). Further, the timestamps may be generated and/or represented in any suitable way and according to any suitable algorithm. For example, in some embodiments, the timestamps are generated based on a timing signal synchronized to a corresponding timing signal of the verification computing device 102 or another timing source as indicated above.

In other embodiments, the timestamps may be generated as a “delta” value (e.g., number of ticks) or temporal offset relative to a time value or count transmitted by the verification computing device 102. That is, timestamps representing times subsequent to the initial transmission from the verification computing device 102 may be represented as deltas of an input value corresponding with the departure time of the network packet from the verification computing device 102 such that the timestamps may be implemented with counters that increment at a known rate. For examples, in an embodiment involving three hops, the verification computing device 102 may generate a timestamp T1, which is equal to a particular count (e.g., a tick count). Depending on the particular embodiment, the timestamp from the verification computing device 102 may be represented as an absolute time, a relative time, a fixed value (e.g., 0), or a random number. The next computing device 106 may generate a timestamp T2=T1+Δ₁, where Δ₁ is equal to a difference in the number of counts between an entry time and a departure time of the packet to/from that computing device 106. The subsequent computing device 106 may generate a timestamp T3=T2+Δ₁=T1+Δ₁+Δ₂, where Δ₂ is equal to a difference in the number of counts between an entry time and a departure time of the packet to/from that subsequent computing device 106. Similarly, the target computing device 106 may generate a timestamp T4=T3+Δ₃=T1+Δ₁+Δ₂+Δ₃. In some embodiments, it should be appreciated that the timestamps (e.g., counter values) may be associated with a processing time between the entry and departure times instead of representing the entry and/or departure times themselves.

The communication module 406 handles the communication between the computing device 106 and remote devices (e.g., the verification computing device 102 and other computing devices 106) through the network 104. For example, as described herein, the communication module 406 receives secure trace packets from a previous computing device 102, 106 in the network flow and cryptographically-signed secure trace packets from a subsequent computing device 106 in the network flow. Additionally, the computing device 106 cryptographically signs and transmits the signed secure trace packets to the previous computing device 102, 106. Accordingly, it should be appreciated that, depending on where the computing device 106 is ordered within the network flow, the computing device 106 may cryptographically sign a secure trace packet that has already been signed. In other words, the secure trace packets may be iteratively signed or “wrapped.”

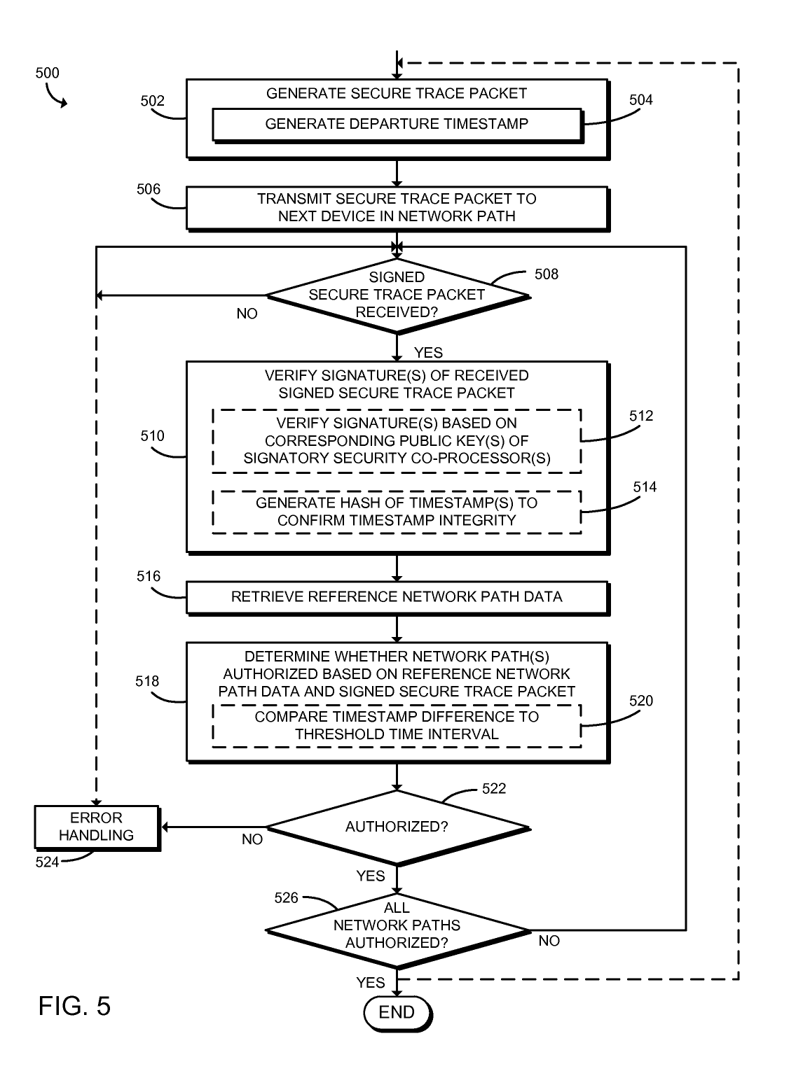

Referring now to FIG. 5, in use, the verification computing device 102 may execute a method 500 for geolocation attestation of computing devices 106 in a network path. As indicated above, in some embodiments, the verification computing device 102 is the source of the network packet, whereas in other embodiments, the verification computing device 102 is not included in the network path. However, for clarity of the description, the verification computing device 102 is assumed to be the source of the network packet to be transmitted to the target computing device 106. The illustrative method 500 begins with block 502 in which the verification computing device 102 generates a secure trace packet. In doing so, in block 504, the computing device 102 generates a departure timestamp indicative of a departure time of the network packet including the secure trace packet to the next computing device 106 in the network path. As indicated above, the computing device 102 may utilize any technique and/or algorithm to generate the timestamp and include the timestamp in the secure trace packet. Depending on the particular embodiment, the secure trace packet may include various other information useful for the performing the functions described herein (e.g., device identifiers, etc.). In block 506, the computing device 102 transmits the secure trace packet to the next computing device 106 in the network path. It should be appreciated that the number of computing devices 102, 106 in the network path from the computing device 102 to the target computing device 106 may vary depending on the particular circumstances (e.g., data center architecture, current computational overhead, etc.), and the order of the computing devices 106 in the network path may be identified, for example, in a network path table.

In block 508, the computing device 102 determines whether a signed secure trace packet has been received. As described herein and illustratively shown in FIG. 8, at each hop of the network path, the corresponding computing device 106 cryptographically signs the secure trace packet received from the previous computing device 102, 106 and sends the signed secure trace packet back to the verification computing device 102 (e.g., through other computing devices 106 via a reverse direction of the network path). Accordingly, in the illustrative embodiment, the computing device 102 receives signed secure trace packets equal in number to the number of computing devices 106 in the network path. Of course, as indicated above, the number of signatures on a particular secure trace packet may vary depending on which computing device 102, 106 initially transmitted the secure trace packet. In some embodiments, if the computing device 102 does not receive the signed secure trace packet within a predefined amount of time, the method 500 advances to block 524 to perform a suitable error handling procedure (e.g., a timeout procedure).

If a signed secure trace packet has been received, the verification computing device 102 verifies the signature(s) of the signed secure trace packet in block 510. As indicated above, in some embodiments, the computing devices 106 cryptographically sign the secure trace packets with a private cryptographic key or, more specifically, a private cryptographic key of the security co-processor 120 of the computing device 106 (e.g., a private TPM key). It should be appreciated that, in the illustrative embodiment, the computing device 102 has access to each of the public cryptographic keys corresponding with the private cryptographic keys used to sign the secure trace packets. Further, as indicated above, the secure trace packet may be signed by multiple private cryptographic keys in some embodiments.

In block 512, the computing device 102 may verify the signature(s) based on the corresponding cryptographic public key(s) of the signatory security co-processor(s) 120. That is, the computing device 102 may verify each of the signatures of the secure trace packet based on a public cryptographic key corresponding with the private cryptographic key (e.g., of the security co-processor 120) of the computing device 106 that generated the particular signature. Further, as indicated above, the computing devices 106 may generate a hash (e.g., a keyed cryptographic hash) of the timestamp(s) of the secure trace packet and include the hash in or with the secure trace packet. Accordingly, in block 514, the computing device 102 may generate a hash of the timestamp(s) included in the secure trace packet in order to confirm the integrity of the timestamp(s) based on the generated hash and the hash included in the secure trace packet.

In block 516, the computing device 102 retrieves the reference network path data 310 (e.g., from memory, data storage, or a remote computing device). As discussed above, the reference network path data 310 may be embodied as any data associated with or capable of conveying a geographical location, geographical boundary, physical path, and/or other expected characteristics of a network path through which a data packet is to be transmitted. For example, in some embodiments, the reference network path data 310 is indicative of a maximum allowed geographical distance between two computing devices 102, 106 in the network path (e.g., a threshold time interval indicative of a duration of travel that corresponds with the maximum allowed geographical distance).

In block 518, the computing device 102 determines whether one or more of the network paths associated with the secure trace packets are authorized based on the reference network path data 310 and the signed secure trace packet. As discussed herein, in the illustrative embodiment, the network path may include one or more sub-paths defined as the single hop or link between two computing devices in the network path. In block 520, the computing device 102 may generate a difference between the relevant timestamps and compare the timestamp difference to a threshold time interval to determine, for example, whether a sub-path of the network path between two computing devices 102, 106 took longer than expected. In some embodiments, communications between two computing devices 102, 106 exceeding the threshold time interval may be indicative of one of the computing devices 106 being outside the authorized geographical region (e.g., within a particular data center). It should be appreciated that, in the illustrative embodiment, the difference in the departure timestamp and entry timestamp of consecutive computing devices 102, 106 is indicative of a duration it takes for the receiving computing device 106 to receive the secure trace packet over the corresponding network 104 and generate a new timestamp (e.g., an entry timestamp). In some embodiments, the computing devices 106 may include additional timestamps in the secure trace packet, which may be used to establish a more robust timeline for confirming the network path (e.g., a time at which the secure trace packet is signed, etc.).

If the computing device 102 determines, in block 522, that the network path is not authorized, the computing device 102 performs one or more error handling functions in block 524. For example, in some embodiments, if a sufficiently low hop time (i.e., below a threshold time interval) is not observed, the computing device 102 may instruct the corresponding computing device 106 to retry the transmission. In doing so, the computing device 102 may confirm that the slow hop was from network latency and/or other acceptable latency factors and not from a computing device 106 being outside the authorized region. Of course, in other embodiments, the computing device 102 may employ any other suitable error handling mechanism.

If the computing device 102 determines, in block 522, that the network path is authorized, the computing device 102 determines whether all of the network paths have been authorized in block 526. In other words, in the illustrative embodiment, the computing device 102 confirms that each sub-path between the computing devices 102 has been authorized. Further, the computing device 102 may ensure that the overall network path is authorized. If the computing device 102 determines that one or more network paths (e.g., sub-paths) remain to be confirmed, the method returns to block 508 in which the computing device 102 waits to receive another signed secure trace packet. It should be appreciated that one or more of the functions described herein may be performed in parallel or in another order. For example, in some embodiments, multiple network paths may be confirmed simultaneously.

As illustrated and discussed below in reference to FIG. 8, depending on the particular embodiment, the verification computing device 102 may perform the authorization in stages or sub-flows. For example, the verification computing device 102 may first determine whether the next computing device 106 in the network flow (i.e., in the network route between the verification computing device 102 and the target computing device 106) is operating within the authorized geolocation. If so, the verification computing device 102 may then determine whether the subsequent computing device 106 in the network flow is operating within the authorized geolocation, and so on, until all computing devices 106 in the network flow are authorized. In doing so, in some embodiments, the verification computing device 102 may authorize the subsequent computing devices 106 in stages or sub-flows (e.g., the sub-flows 802, 804, 806 of FIG. 8) such that each of the intermediate computing devices 106 are re-assessed when determining whether a particular computing device 106 in the network flow is authorized. As described below, doing so may provide additional temporal information that may be used to more accurately determine whether the computing devices 106 are indeed within authorized geolocations. In such embodiments, the method 500 may be executed by the verification computing device 102 for each of the stages or sub-flows. However, in other embodiments, the method 500 may be executed only once for the authorization of a particular target computing device 106.

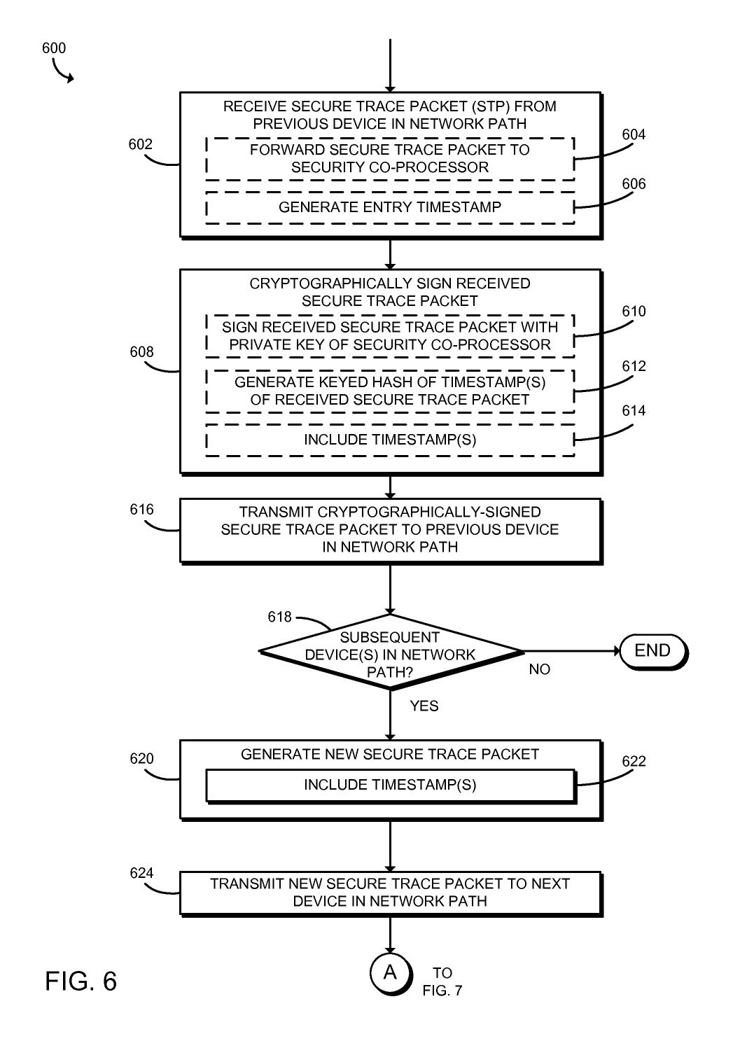

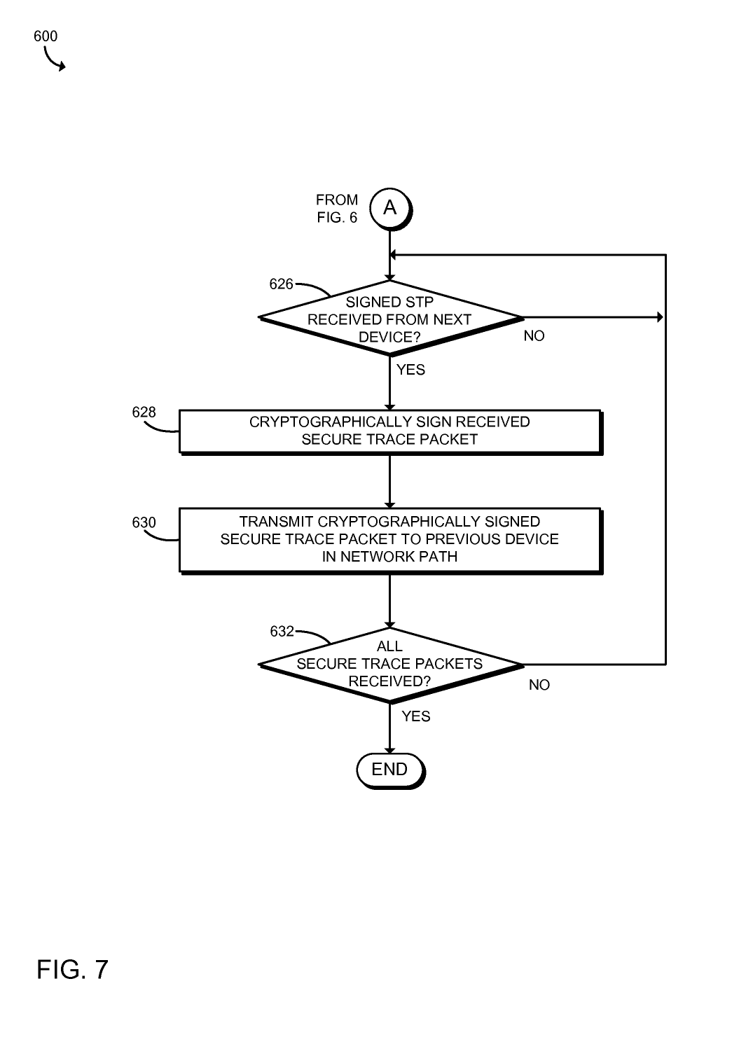

Referring now to FIGS. 6-7, in use, each of the computing devices 106 may execute a method 600 for facilitating attestation of the geolocation of computing devices 106 in a network path. The illustrative method 600 begins with block 602 in which the computing device 106 receives a secure trace packet from the previous computing device 102, 106 in the network path. It should be appreciated that the network path from the source computing device (e.g., the verification computing device 102) to the target computing device 106 may be predetermined and stored, for example, in a network path table. Accordingly, if the computing device 106 is the second computing device in the network path, the previous computing device is the verification computing device 102. Otherwise, the previous computing device is another computing device 106 (e.g., intermediate computing devices).

In some embodiments, in block 604, the computing device 106 may forward the received secure trace packet to the security co-processor 120 of the computing device 106. In particular, the network controller 126 may include a sideband filtering capability to route the secure trace packets to the security co-processor 120 (e.g., via an out-of-band communication channel) and route other network packets through traditional in-band communication channels depending on the particular network packet. For example, the network controller 126 may route network packets to the security co-processor 120 over in-band communication channels if a typical attestation of the host system is requested. Further, in some embodiments, communications with the security co-processor 120 by virtue of the two communication channels (e.g., the in-band communication channel and the out-of-band communication channel) may be used, for example, to confirm the identity of that particular computing device 106. In some embodiments, the network controller 125 routes the secure trace packets to the management device 124, which in turn forwards the packets to the security co-processor 120. Additionally, in block 606, the computing device 106 may generate an entry timestamp indicative of a receipt time of the secure trace packet by the computing device 106.

In block 608, the computing device 106 cryptographically signs the received secure trace packet. In doing so, the computing device 106 may sign the secure trace packet with the private cryptographic key of the security co-processor 120 in block 610. As indicated above, in the illustrative embodiment, the verification computing device 102 has access to the corresponding public cryptographic key of the security co-processor 120. In block 612, the computing device 106 may generate a keyed hash of the timestamp(s) of the received secure trace packet based on the private cryptographic key of the computing device 106. In some embodiments, the computing device 102, 106 that originally generated the timestamp includes such a hash to allow verification of the integrity of the timestamp by other computing devices 102, 106. In some embodiments, in block 614, the computing device 106 includes one or more timestamps generated by the computing device 106 in/with the cryptographically-signed secure trace packet. For example, the computing device 106 may include the entry timestamp generated in block 606 and/or a departure timestamp corresponding with a departure time of the cryptographically-signed secure trace packet to the previous computing device 102, 106. In block 616, the computing device 102 transmits the cryptographically-signed secure trace packet to the previous computing device 102, 106 in the network path.

In block 618, the computing device 106 determines whether there are any subsequent computing devices 106 in the network path. In some embodiments, the computing device 106 may make such determination by referencing a network path table that identifies each of the computing devices 106 and their corresponding order in the network path for a particular network packet transmission. If there are subsequent computing devices 106 in the network path, the computing device 106 generates a new secure trace packet in block 620. Additionally, in block 622, the computing device 106 includes one or more timestamps generated by the computing device 106 in/with the cryptographically-signed secure trace packet. For example, the computing device 106 may include the entry timestamp generated in block 606 and/or a departure timestamp corresponding with a departure time of the new secure trace packet to the next computing device 106 in the network path. It should be appreciated that the new secure trace packet may also include one or more of the timestamps generated by previous computing devices 102, 106 in the network path as described below in reference to FIG. 8. For example, in some embodiments, the new secure trace packet may include timestamps indicative of the departure time of the packet from the verification device and the entry and departure times of the packet from any other intermediate computing devices 106 in the network path between the verification computing device 102 and the computing device 106. In block 620, the computing device 106 transmits the new secure trace packet to the next computing device 106 in the network path.

In block 626 of FIG. 7, the computing device 106 determines whether a signed secure trace packet has been received from the next computing device 106 in the network packet. In other words, in the illustrative embodiment, after transmitting the secure trace network packet to the next computing device 106, the computing device 106 waits until it receives a response including a signature of the secure trace network packet. If a secure trace network packet has been received, the computing device 106 cryptographically signs the received packet in block 628. As indicated above, the computing device 106 may sign the secure trace packet with the private cryptographic key of the computing device 106 (e.g., a private TPM key). It should be appreciated that, in the illustrative embodiment, the secure trace packet will have been iteratively signed by each of the subsequent computing devices 106 in the network path.

In block 630, the computing device 106 transmits the cryptographically-signed secure trace packet to the previous computing device 102, 106 in the network path. In block 632, the computing device 106 determines whether all of the secure trace packets have been received. It should be appreciated that, in the illustrative embodiment, the total number of signed secure trace packets received by the computing device 106 from subsequent computing devices 106 is equal to the number of subsequent computing devices 106. If all of the secure trace packets have not been received, the method 600 returns to block 626 of FIG. 7 in which the computing device 106 waits to receive the next signed secure trace packet.

Referring now to FIG. 8, in use, the computing devices 102, 106 may execute a method 800 for attesting the geolocation of computing devices 106 in a network path. The illustrative method 800 includes three sub-flows, which may be executed separately or together depending on the particular embodiment. It should be appreciated that FIG. 8 depicts the cryptographic signatures as being applied to the timestamps themselves for clarity. However, the computing devices 106 may cryptographically sign the secure trace packets (rather than the timestamps themselves) in some embodiments.

In a first sub-flow 802, the first computing device 106 is the target computing device. As shown, the verification computing device 102 generates a departure timestamp T1 and transmits the timestamp T1 or, more particularly, the secure trace packet including the timestamp to the first computing device 106. As indicated above, the computing devices 106 may generate an entry timestamp upon receiving a secure trace packet from the previous computing device 102, 106 in the network flow. Similarly, the computing devices 106 may generate departure timestamps corresponding with the departure times of packets from the computing devices 106 to the previous computing device 102, 106 and/or the subsequent computing device 106. For clarity of the description, the entry and/or departure timestamps generated and transmitted by a particular computing device 106 may be referred to herein collectively as a single timestamp.

In the illustrative embodiment, the first computing device 106 generates entry and/or departure timestamps T2, cryptographically signs the timestamps T1 and T2 (e.g., with a private TPM key of the first computing device 106) to generate a cryptographically-signed secure trace packet S_{K1} (T1, T2), and transmits the cryptographically-signed secure trace packet S_{K1} (T1, T2) to the verification computing device 102. The verification computing device 102 may verify the signature based on the corresponding public cryptographic key and utilize the timestamps T1 and T2 to determine whether the computing device 106 is within an authorized geolocation as described above.

In a second sub-flow 804, the second computing device 106 is the target computing device. As shown, the verification computing device 102 generates a timestamp T3 and transmits the timestamp T3 to the first computing device 106. The first computing device 106 generates entry and/or departure timestamps T4, cryptographically signs the timestamps T3 and T4 (e.g., with a private TPM key of the first computing device 106) to generate a cryptographically-signed secure trace packet S_{K1}(T3,T4), and transmits the cryptographically-signed secure trace packet S_{K1}(T3,T4) to the verification computing device 102. Additionally, the first computing device 106 transmits the timestamps T3 and T4 to the second computing device 106. As indicated above, it should be appreciated that, in some embodiments, the timestamp(s) T4 transmitted to the second computing device 106 may be different from the timestamp(s) T4 transmitted to the verification computing device 102. For example, in some embodiments, the timestamp(s) T4 transmitted to the two different computing devices 102, 106 may correspond with different corresponding departure times. However, in other embodiments, the network packets may be transmitted in parallel such that the timestamps coincide with one another.

The second computing device 106 generates entry and/or departure timestamps T5, cryptographically signs the set of timestamps T3, T4, and T5 (e.g., with a private TPM key of the second computing device 106) to generate a cryptographically-signed secure trace packet S_{K2}(T3,T4,T5), and transmits the cryptographically-signed secure trace packet S_{K2}(T3,T4,T5) to the first computing device 106. The first computing device 106 cryptographically signs the secure trace packet S_{K2}(T3,T4,T5) again to generate a multiply signed secure trace packet S_{K1}(S_{K2}(T3,T4,T5)) and transmits it to the verification computing device 102. The verification computing device 102 may verify the signature of the first computing device 106 and then the signature of the second computing device 106 and utilize the timestamps to determine whether each of the network sub-paths is authorized. In particular, the computing device 102 may confirm that both the first and second computing devices 106 are within authorized geolocations (e.g., based on the temporal characteristics associated with the sub-paths between the verification computing device 102 and the first computing device 106 and between the first and second computing devices 106).

In a third sub-flow 806, the third computing device 106 is the target computing device. As shown, the third sub-flow 806 is an expansion of the second sub-flow 804 for embodiments in which there are three hops in the network flow (i.e., three computing devices 106). In some embodiments, each of the sub-flows 802, 804, 806 may be utilized for robust attestation of the geolocation of a target computing device 106 that is three hops away and the intermediate computing devices 106. For example, the timestamps received by the verification computing device 102 in the first sub-flow 802 may be compared to the corresponding timestamps of the second sub-flow 804 and the third sub-flow 806. In particular, the difference between the timestamps T1 and T2 of the first sub-flow 802 (i.e., the difference between the departure timestamp of the secure trace packet from the verification computing device 102 to the first computing device 106 and the receipt or entry timestamp of that packet by the first computing device 106) may be compared to the difference between the timestamps T3 and T4 of the second sub-flow 804 and the difference between the timestamps T6 and T7 of the third sub-flow. In the illustrative embodiment, the results should be relatively close such that a significant timing difference between the results could indicate that an unauthorized network path was taken. Similarly, the timestamps of the second sub-flow 804 may be compared to the corresponding timestamps of the third sub-flow 806. In other embodiments, the system 100 may utilize only the sub-flow 802 to verify a one-hop network flow, the sub-flow 804 to verify a two-hop network flow, the sub-flow 806 to verify a three-hop network flow, and so on. It should be appreciated that the techniques described herein may be expanded for any number of hops.

In an alternative embodiment, the verification computing device 102 may access each of the computing devices 106 in the network flow directly and request the computing devices 106 to check its immediate neighbor (e.g., the next computing device 106) and retrieve the result. For example, suppose the system 100 includes the verification computing device 102 (device V) and three computing devices 102 (devices A, B, and C wherein device C is the target computing device 106) such that the network path to be verified is the A-B-C path (i.e., the path between those corresponding devices in the same order). In such an embodiment, the verification computing device 102 may check its direct communication connections with devices A, B, and C. Further, the verification computing device 102 may check the V-A-B path and the V-B-C path and, using those results, infer the validity of the A-B-C path. It should be appreciated that such an embodiment may be expanded for a network path having any number of hops.

### Examples

Illustrative examples of the technologies disclosed herein are provided below. An embodiment of the technologies may include any one or more, and any combination of, the examples described below.

Example 1 includes a verification computing device for geolocation attestation of computing devices in a network path, the verification computing device comprising a secure trace packet generation module to generate a secure trace packet, wherein the secure trace packet includes a timestamp that corresponds with a departure time of the secure trace packet from the verification computing device; a communication module to transmit the secure trace packet to a computing device in the network path, wherein the network path identifies one or more intermediate computing devices through which to communicate the secure trace packet from the verification computing device to a target computing device; a cryptographic module to verify a signature of a cryptographically-signed secure trace packet received by the verification computing device from the computing device; and a network path authorization module to determine whether a sub-path of the network path is authorized based on reference network path data and the cryptographically-signed secure trace packet, wherein the reference network path data is indicative of a maximum allowed geographical distance between two computing devices in the network path.

Example 2 includes the subject matter of Example 1, and wherein to generate the secure trace packet comprises to generate the timestamp with a secure timing source of the verification computing device.

Example 3 includes the subject matter of any of Examples 1 and 2, and wherein to verify the signature comprises to verify a signature of the computing device.

Example 4 includes the subject matter of any of Examples 1-3, and wherein to verify the signature of the computing device comprises to verify a first signature of the cryptographically-signed secure trace packet; and wherein the cryptographic module is further to verify a second signature of the cryptographically-signed secure trace packet, wherein the second signature is a signature of another computing device of the one or more intermediate computing devices in the network path.

Example 5 includes the subject matter of any of Examples 1-4, and wherein to verify the signature comprises to verify the signature based on a public cryptographic key that corresponds with a private cryptographic key of a security co-processor of the computing device.

Example 6 includes the subject matter of any of Examples 1-5, and wherein to verify the signature comprises to generate a hash of the timestamp; and confirm an integrity of the timestamp based on the generated hash and a reference hash included in the secure trace packet.

Example 7 includes the subject matter of any of Examples 1-6, and wherein to determine whether the sub-path of the network path is authorized comprises to compare a difference between the timestamp and an entry timestamp included with the cryptographically-signed secure trace packet to a threshold time interval indicative of a duration of travel associated with the maximum allowed geographical distance, wherein the entry timestamp corresponds with a receipt time of the secure trace packet by the computing device from the verification computing device.

Example 8 includes the subject matter of any of Examples 1-7, and wherein the entry timestamp comprises a timestamp generated as a function of a timing signal that is synchronous with a secure timing source of the verification computing device.

Example 9 includes the subject matter of any of Examples 1-8, and wherein the entry timestamp comprises a timestamp generated as a function of a counter incremented at a known rate.

Example 10 includes the subject matter of any of Examples 1-9, and wherein to determine whether the sub-path of the network path is authorized comprises to determine whether a sub-path of the network path is authorized based on a processing time of the secure trace packet, by the computing device, identified in the cryptographically-signed secure trace packet.

Example 11 includes the subject matter of any of Examples 1-10, and wherein to determine whether the sub-path of the network is authorized comprises to determine whether a first sub-path of the network path is authorized; and wherein the network path authorization module is further to determine whether a second sub-path of the network path is authorized based on the reference network path data and the cryptographically-signed secure trace packet.

Example 12 includes the subject matter of any of Examples 1-11, and wherein the network path authorization module is further to determine whether each sub-path of the network path is authorized based on the reference network path data and the cryptographically-signed secure trace packet.

Example 13 includes a method for attesting the geolocation of computing devices in a network path, the method comprising generating, by a verification computing device, a secure trace packet that includes a timestamp corresponding with a departure time of the secure trace packet from the verification computing device; transmitting, by the verification computing device, the secure trace packet to a computing device in the network path, wherein the network path identifies one or more intermediate computing devices through which to communicate the secure trace packet from the verification computing device to a target computing device; verifying, by the verification computing device, a signature of a cryptographically-signed secure trace packet received by the verification computing device from the computing device; and determining, by the verification computing device, whether a sub-path of the network path is authorized based on reference network path data and the cryptographically-signed secure trace packet, wherein the reference network path data is indicative of a maximum allowed geographical distance between two computing devices in the network path.

Example 14 includes the subject matter of Example 13, and wherein generating the secure trace packet comprises generating the timestamp with a secure timing source of the verification computing device.

Example 15 includes the subject matter of any of Examples 13 and 14, and wherein verifying the signature comprises verifying a signature of the computing device.

Example 16 includes the subject matter of any of Examples 13-15, and wherein verifying the signature of the computing device comprises verifying a first signature of the cryptographically-signed secure trace packet; and further comprising verifying, by the verification computing device, a second signature of the cryptographically-signed secure trace packet, wherein the second signature is a signature of another computing device of the one or more intermediate computing devices in the network path.

Example 17 includes the subject matter of any of Examples 13-16, and wherein verifying the signature comprises verifying the signature based on a public cryptographic key corresponding with a private cryptographic key of a security co-processor of the computing device.

Example 18 includes the subject matter of any of Examples 13-17, and wherein verifying the signature comprises generating a hash of the timestamp; and confirming an integrity of the timestamp based on the generated hash and a reference hash included in the secure trace packet.

Example 19 includes the subject matter of any of Examples 13-18, and wherein determining whether the sub-path of the network path is authorized comprises comparing a difference between the timestamp and an entry timestamp included with the cryptographically-signed secure trace packet to a threshold time interval indicative of a duration of travel associated with the maximum allowed geographical distance, wherein the entry timestamp corresponds with a receipt time of the secure trace packet by the computing device from the verification computing device.

Example 20 includes the subject matter of any of Examples 13-19, and wherein the entry timestamp comprises a timestamp generated as a function of a timing signal that is synchronous with a secure timing source of the verification computing device.

Example 21 includes the subject matter of any of Examples 13-20, and wherein the entry timestamp comprises a timestamp generated as a function of a counter incremented at a known rate.

Example 22 includes the subject matter of any of Examples 13-21, and wherein determining whether the sub-path of the network path is authorized comprises determining whether a sub-path of the network path is authorized based on a processing time of the secure trace packet, by the computing device, identified in the cryptographically-signed secure trace packet.

Example 23 includes the subject matter of any of Examples 13-22, and wherein determining whether the sub-path of the network is authorized comprises determining whether a first sub-path of the network path is authorized; and further comprising determining, by the verification computing device, whether a second sub-path of the network path is authorized based on the reference network path data and the cryptographically-signed secure trace packet.

Example 24 includes the subject matter of any of Examples 13-23, and further including determining, by the verification computing device, whether each sub-path of the network path is authorized based on the reference network path data and the cryptographically-signed secure trace packet.

Example 25 includes a computing device comprising a processor; and a memory having stored therein a plurality of instructions that when executed by the processor cause the computing device to perform the method of any of Examples 13-24.

Example 26 includes one or more machine-readable storage media comprising a plurality of instructions stored thereon that, in response to execution by a computing device, cause the computing device to perform the method of any of Examples 13-24.

Example 27 includes a verification computing device for geolocation attestation of computing devices in a network path, the verification computing device comprising means for generating a secure trace packet that includes a timestamp corresponding with a departure time of the secure trace packet from the verification computing device; means for transmitting the secure trace packet to a computing device in the network path, wherein the network path identifies one or more intermediate computing devices through which to communicate the secure trace packet from the verification computing device to a target computing device; means for verifying a signature of a cryptographically-signed secure trace packet received by the verification computing device from the computing device; and means for determining whether a sub-path of the network path is authorized based on reference network path data and the cryptographically-signed secure trace packet, wherein the reference network path data is indicative of a maximum allowed geographical distance between two computing devices in the network path.

Example 28 includes the subject matter of Example 27, and wherein the means for generating the secure trace packet comprises means for generating the timestamp with a secure timing source of the verification computing device.

Example 29 includes the subject matter of any of Examples 27 and 28, and wherein the means for verifying the signature comprises means for verifying a signature of the computing device.

Example 30 includes the subject matter of any of Examples 27-29, and wherein the means for verifying the signature of the computing device comprises means for verifying a first signature of the cryptographically-signed secure trace packet; and further comprising means for verifying a second signature of the cryptographically-signed secure trace packet, wherein the second signature is a signature of another computing device of the one or more intermediate computing devices in the network path.

Example 31 includes the subject matter of any of Examples 27-30, and wherein the means for verifying the signature comprises means for verifying the signature based on a public cryptographic key corresponding with a private cryptographic key of a security co-processor of the computing device.

Example 32 includes the subject matter of any of Examples 27-31, and wherein the means for verifying the signature comprises means for generating a hash of the timestamp; and means for confirming an integrity of the timestamp based on the generated hash and a reference hash included in the secure trace packet.

Example 33 includes the subject matter of any of Examples 27-32, and wherein the means for determining whether the sub-path of the network path is authorized comprises means for comparing a difference between the timestamp and an entry timestamp included with the cryptographically-signed secure trace packet to a threshold time interval indicative of a duration of travel associated with the maximum allowed geographical distance, wherein the entry timestamp corresponds with a receipt time of the secure trace packet by the computing device from the verification computing device.

Example 34 includes the subject matter of any of Examples 27-33, and, wherein the entry timestamp comprises a timestamp generated as a function of a timing signal that is synchronous with a secure timing source of the verification computing device.

Example 35 includes the subject matter of any of Examples 27-34, and wherein the entry timestamp comprises a timestamp generated as a function of a counter incremented at a known rate.

Example 36 includes the subject matter of any of Examples 27-35, and wherein the means for determining whether the sub-path of the network path is authorized comprises determining whether a sub-path of the network path is authorized based on a processing time of the secure trace packet, by the computing device, identified in the cryptographically-signed secure trace packet.

Example 37 includes the subject matter of any of Examples 27-36, and wherein determining whether the sub-path of the network is authorized comprises means for determining whether a first sub-path of the network path is authorized; and further comprising means for determining whether a second sub-path of the network path is authorized based on the reference network path data and the cryptographically-signed secure trace packet.

Example 38 includes the subject matter of any of Examples 27-37, and further including means for determining whether each sub-path of the network path is authorized based on the reference network path data and the cryptographically-signed secure trace packet.

Example 39 includes a computing device for facilitating attestation of the geolocation of computing devices in a network path, the computing device comprising a communication module to receive a secure trace packet from a previous computing device in the network path, wherein the secure trace packet includes a first timestamp corresponding with a departure time of the secure trace packet from the previous computing device to the computing device; and a cryptography module to sign the received secure trace packet with a private cryptographic key of the computing device; and wherein the communication module is further to transmit the cryptographically-signed secure trace packet to the previous computing device in the network path, wherein the cryptographically-signed secure trace packet includes a second timestamp indicative of a receipt time of the secure trace packet by the computing device.

Example 40 includes the subject matter of Example 39, and further including a network controller and a security co-processor, wherein to receive the secure trace packet comprises to forward the secure trace packet from the network controller to the security co-processor over an out-of-band communication link.

Example 41 includes the subject matter of any of Examples 39 and 40, and further including a security co-processor, wherein to sign the received secure trace packet comprises to sign the secure trace packet with a private cryptographic key of the security co-processor of the computing device.

Example 42 includes the subject matter of any of Examples 39-41, and wherein to sign the received secure trace packet comprises to generate a keyed hash of the first timestamp.

Example 43 includes the subject matter of any of Examples 39-42, and further including a secure trace packet generation module to (i) determine whether the network path includes a subsequent computing device and (ii) generate a new secure trace packet in response to a determination that the network path includes the subsequent computing device; and wherein the communication module is further to transmit the new secure trace packet to the subsequent computing device.

Example 44 includes the subject matter of any of Examples 39-43, and wherein to generate the new secure trace packet comprises to generate a third timestamp indicative of a departure time of the new secure trace packet from the computing device to the subsequent computing device.

Example 45 includes the subject matter of any of Examples 39-44, and wherein to generate the third timestamp comprises to generate the third timestamp with a secure timing source of the computing device.

Example 46 includes the subject matter of any of Examples 39-45, and wherein the third timestamp comprises a timestamp generated as a function of a timing signal that is synchronous with a secure timing source of a remote computing device.

Example 47 includes the subject matter of any of Examples 39-46, and wherein the third timestamp comprises a timestamp generated as a function of a counter incremented at a known rate.

Example 48 includes the subject matter of any of Examples 39-47, and wherein the communication module is further to receive a cryptographically-signed secure trace packet from the subsequent computing device; wherein the cryptography module is further to sign the cryptographically-signed secure trace packet with the private cryptographic key of the computing device to generate a multiply signed secure trace packet; and wherein the communication module is to transmit the multiply signed secure trace packet to the previous device.

Example 49 includes the subject matter of any of Examples 39-48, and wherein to generate the new secure trace packet comprises to generate a third timestamp indicative of a processing time of the computing device elapsed between receipt of the secure trace packet and transmission of the cryptographically-signed secure trace packet.

Example 50 includes a method for facilitating attestation of the geolocation of computing devices in a network path, the method comprising receiving, by a computing device, a secure trace packet from a previous computing device in the network path, wherein the secure trace packet includes a first timestamp corresponding with a departure time of the secure trace packet from the previous computing device to the computing device; signing, by the computing device, the received secure trace packet with a private cryptographic key of the computing device; and transmitting, by the computing device, the cryptographically-signed secure trace packet to the previous computing device in the network path, wherein the cryptographically-signed secure trace packet includes a second timestamp indicative of a receipt time of the secure trace packet by the computing device.

Example 51 includes the subject matter of Example 50, and wherein receiving the secure trace packet comprises forwarding the secure trace packet from a network controller of the computing device to a security co-processor of the computing device over an out-of-band communication link.

Example 52 includes the subject matter of any of Examples 50 and 51, and wherein signing the received secure trace packet comprises signing the secure trace packet with a private cryptographic key of a security co-processor of the computing device.

Example 53 includes the subject matter of any of Examples 50-52, and wherein signing the received secure trace packet comprises generating a keyed hash of the timestamp.

Example 54 includes the subject matter of any of Examples 50-53, and further including determining, by the computing device, whether the network path includes a subsequent computing device; generating, by the computing device, a new secure trace packet in response to determining the network path includes the subsequent computing device; and transmitting, by the computing device, the new secure trace packet to the subsequent computing device.

Example 55 includes the subject matter of any of Examples 50-54, and wherein generating the new secure trace packet comprises generating a third timestamp indicative of a departure time of the new secure trace packet from the computing device to the subsequent computing device.

Example 56 includes the subject matter of any of Examples 50-55, and wherein generating the third timestamp comprises generating the third timestamp with a secure timing source of the computing device.

Example 57 includes the subject matter of any of Examples 50-56, and wherein the third timestamp comprises a timestamp generated as a function of a timing signal that is synchronous with a secure timing source of a remote computing device.

Example 58 includes the subject matter of any of Examples 50-57, and wherein the third timestamp comprises a timestamp generated as a function of a counter incremented at a known rate.

Example 59 includes the subject matter of any of Examples 50-58, and further including receiving, by the computing device, a cryptographically-signed secure trace packet from the subsequent computing device; signing, by the computing device, the cryptographically-signed secure trace packet with the private cryptographic key of the computing device to generate a multiply signed secure trace packet; and transmitting, by the computing device, the multiply signed secure trace packet to the previous device.

Example 60 includes the subject matter of any of Examples 50-59, and wherein generating the new secure trace packet comprises generating a third timestamp indicative of a processing time of the computing device elapsed between receipt of the secure trace packet and transmission of the cryptographically-signed secure trace packet.

Example 61 includes a computing device comprising a processor; and a memory having stored therein a plurality of instructions that when executed by the processor cause the computing device to perform the method of any of Example 50-60.

Examples 62 includes one or more machine-readable storage media comprising a plurality of instructions stored thereon that, in response to execution by a computing device, cause the computing device to perform the method of any of Examples 50-60.

Example 63 includes a computing device for facilitating attestation of the geolocation of computing devices in a network path, the computing device comprising means for receiving a secure trace packet from a previous computing device in the network path, wherein the secure trace packet includes a first timestamp corresponding with a departure time of the secure trace packet from the previous computing device to the computing device; means for signing the received secure trace packet with a private cryptographic key of the computing device; and means for transmitting the cryptographically-signed secure trace packet to the previous computing device in the network path, wherein the cryptographically-signed secure trace packet includes a second timestamp indicative of a receipt time of the secure trace packet by the computing device.

Example 64 includes the subject matter of Example 63, and wherein the means for receiving the secure trace packet comprises means for forwarding the secure trace packet from a network controller of the computing device to a security co-processor of the computing device over an out-of-band communication link.

Example 65 includes the subject matter of any of Examples 63 and 64, and wherein the means for signing the received secure trace packet comprises means for signing the secure trace packet with a private cryptographic key of a security co-processor of the computing device.

Example 66 includes the subject matter of any of Examples 63-65, and wherein the means for signing the received secure trace packet comprises means for generating a keyed hash of the timestamp.

Example 67 includes the subject matter of any of Examples 63-66, and further including means for determining whether the network path includes a subsequent computing device; means for generating a new secure trace packet in response to determining the network path includes the subsequent computing device; and means for transmitting the new secure trace packet to the subsequent computing device.

Example 68 includes the subject matter of any of Examples 63-67, and the means for generating the new secure trace packet comprises means for generating a third timestamp indicative of a departure time of the new secure trace packet from the computing device to the subsequent computing device.

Example 69 includes the subject matter of any of Examples 63-68, and wherein the means for generating the third timestamp comprises means for generating the third timestamp with a secure timing source of the computing device.

Example 70 includes the subject matter of any of Examples 63-69, and wherein the third timestamp comprises a timestamp generated as a function of a timing signal that is synchronous with a secure timing source of a remote computing device.

Example 71 includes the subject matter of any of Examples 63-70, and wherein the third timestamp comprises a timestamp generated as a function of a counter incremented at a known rate.

Example 72 includes the subject matter of any of Examples 63-71, and further including means for receiving a cryptographically-signed secure trace packet from the subsequent computing device; means for signing the cryptographically-signed secure trace packet with the private cryptographic key of the computing device to generate a multiply signed secure trace packet; and means for transmitting the multiply signed secure trace packet to the previous device.

Example 73 includes the subject matter of any of Examples 63-72, and wherein the means for generating the new secure trace packet comprises means for generating a third timestamp indicative of a processing time of the computing device elapsed between receipt of the secure trace packet and transmission of the cryptographically-signed secure trace packet.

1. A verification computing device for geolocation attestation of computing devices in a network path, the verification computing device comprising:
a secure trace packet generation module to generate a secure trace packet, wherein the secure trace packet includes a timestamp that corresponds with a departure time of the secure trace packet from the verification computing device;
a communication module to transmit the secure trace packet to a computing device in the network path, wherein the network path identifies one or more intermediate computing devices through which to communicate the secure trace packet from the verification computing device to a target computing device;
a cryptographic module to verify a signature of a cryptographically-signed secure trace packet received by the verification computing device from the computing device; and
a network path authorization module to determine whether a sub-path of the network path is authorized based on reference network path data and the cryptographically-signed secure trace packet, wherein the reference network path data is indicative of a maximum allowed geographical distance between two computing devices in the network path.

2. The verification computing device of claim 1, wherein to generate the secure trace packet comprises to generate the timestamp with a secure timing source of the verification computing device.

3. The verification computing device of claim 1, wherein to verify the signature comprises to verify a signature of the computing device.

4. The verification computing device of claim 3, wherein to verify the signature of the computing device comprises to verify a first signature of the cryptographically-signed secure trace packet; and
wherein the cryptographic module is further to verify a second signature of the cryptographically-signed secure trace packet, wherein the second signature is a signature of another computing device of the one or more intermediate computing devices in the network path.

5. The verification computing device of claim 1, wherein to verify the signature comprises to verify the signature based on a public cryptographic key that corresponds with a private cryptographic key of a security co-processor of the computing device.

6. The verification computing device of claim 1, wherein to verify the signature comprises to:
generate a hash of the timestamp; and
confirm an integrity of the timestamp based on the generated hash and a reference hash included in the secure trace packet.

7. One or more machine-readable storage media comprising a plurality of instructions stored thereon that, in response to execution by a verification computing device, cause the verification computing device to:
generate a secure trace packet that includes a timestamp corresponding with a departure time of the secure trace packet from the verification computing device;
transmit the secure trace packet to a computing device in the network path, wherein the network path identifies one or more intermediate computing devices through which to communicate the secure trace packet from the verification computing device to a target computing device;
verify a signature of a cryptographically-signed secure trace packet received by the verification computing device from the computing device; and
determine whether a sub-path of the network path is authorized based on reference network path data and the cryptographically-signed secure trace packet, wherein the reference network path data is indicative of a maximum allowed geographical distance between two computing devices in the network path.

8. The one or more machine-readable storage media of claim 7, wherein to determine whether the sub-path of the network path is authorized comprises to compare a difference between the timestamp and an entry timestamp included with the cryptographically-signed secure trace packet to a threshold time interval indicative of a duration of travel associated with the maximum allowed geographical distance, wherein the entry timestamp corresponds with a receipt time of the secure trace packet by the computing device from the verification computing device.

9. The one or more machine-readable storage media of claim 8, wherein the entry timestamp comprises a timestamp generated as a function of a timing signal that is synchronous with a secure timing source of the verification computing device.

10. The one or more machine-readable storage media of claim 8, wherein the entry timestamp comprises a timestamp generated as a function of a counter incremented at a known rate.

11. The one or more machine-readable storage media of claim 7, wherein to determine whether the sub-path of the network path is authorized comprises to determine whether a sub-path of the network path is authorized based on a processing time of the secure trace packet, by the computing device, identified in the cryptographically-signed secure trace packet.

12. The one or more machine-readable storage media of claim 7, wherein to determine whether the sub-path of the network is authorized comprises to determine whether a first sub-path of the network path is authorized; and
wherein the plurality of instructions further cause the verification computing device to determine whether a second sub-path of the network path is authorized based on the reference network path data and the cryptographically-signed secure trace packet.

13. The one or more machine-readable storage media of claim 7, wherein the plurality of instructions further cause the verification computing device to determine whether each sub-path of the network path is authorized based on the reference network path data and the cryptographically-signed secure trace packet.

14. A computing device for facilitating attestation of the geolocation of computing devices in a network path, the computing device comprising:
a communication module to receive a secure trace packet from a previous computing device in the network path, wherein the secure trace packet includes a first timestamp corresponding with a departure time of the secure trace packet from the previous computing device to the computing device; and
a cryptography module to sign the received secure trace packet with a private cryptographic key of the computing device; and
wherein the communication module is further to transmit the cryptographically-signed secure trace packet to the previous computing device in the network path, wherein the cryptographically-signed secure trace packet includes a second timestamp indicative of a receipt time of the secure trace packet by the computing device.

15. The computing device of claim 14, further comprising a network controller and a security co-processor, wherein to receive the secure trace packet comprises to forward the secure trace packet from the network controller to the security co-processor over an out-of-band communication link.

16. The computing device of claim 14, further comprising a security co-processor, wherein to sign the received secure trace packet comprises to sign the secure trace packet with a private cryptographic key of the security co-processor of the computing device.

17. The computing device of claim 14, wherein to sign the received secure trace packet comprises to generate a keyed hash of the first timestamp.

18. The computing device of claim 14, further comprising a secure trace packet generation module to (i) determine whether the network path includes a subsequent computing device and (ii) generate a new secure trace packet in response to a determination that the network path includes the subsequent computing device; and
wherein the communication module is further to transmit the new secure trace packet to the subsequent computing device.

19. The computing device of claim 18, wherein to generate the new secure trace packet comprises to generate a third timestamp indicative of a departure time of the new secure trace packet from the computing device to the subsequent computing device.

20. The computing device of claim 19, wherein the third timestamp comprises a timestamp generated as a function of a timing signal that is synchronous with a secure timing source of a remote computing device.

21. The computing device of claim 19, wherein the third timestamp comprises a timestamp generated as a function of a counter incremented at a known rate.

22. One or more machine-readable storage media comprising a plurality of instructions stored thereon that, in response to execution by a computing device, cause the computing device to:
receive a secure trace packet from a previous computing device in the network path, wherein the secure trace packet includes a first timestamp corresponding with a departure time of the secure trace packet from the previous computing device to the computing device;
sign the received secure trace packet with a private cryptographic key of the computing device; and
transmit the cryptographically-signed secure trace packet to the previous computing device in the network path, wherein the cryptographically-signed secure trace packet includes a second timestamp indicative of a receipt time of the secure trace packet by the computing device.

23. The one or more machine-readable storage media of claim 22, wherein the plurality of instructions further cause the computing device to:
determine whether the network path includes a subsequent computing device;
generate a new secure trace packet in response to determining the network path includes the subsequent computing device; and
transmit the new secure trace packet to the subsequent computing device.

24. The one or more machine-readable storage media of claim 23, wherein the plurality of instructions further cause the computing device to:
receive a cryptographically-signed secure trace packet from the subsequent computing device;
sign the cryptographically-signed secure trace packet with the private cryptographic key of the computing device to generate a multiply signed secure trace packet; and
transmit the multiply signed secure trace packet to the previous device.

25. The one or more machine-readable storage media of claim 23, wherein to generate the new secure trace packet comprises to generate a third timestamp indicative of a processing time of the computing device elapsed between receipt of the secure trace packet and transmission of the cryptographically-signed secure trace packet.
